(19) United States
(12) Patent Application Publication
(10) Pub. No.: US 2007/0158089 A1
(43) Pub. Date: Jul. 12, 2007

(54) Pneumatic hammer drill (II)

(75) Inventors: Chun-Hao Chen, Taichung Hsien (TW); Yueh-Pei Liu, Taichung Hsien (TW)

Correspondence Address: FITZPATRICK CELLA HARPER & SCINTO, 30 ROCKEFELLER PLAZA, NEW YORK, NY, 10112, US

(73) Assignee: SHUN TAI PRECISION CO., LTD., Taichung Hsien (TW)

(21) Appl. No.: 11/430,955

(22) Filed: May 10, 2006

(30) Foreign Application Priority Data
Jan. 10, 2006 (TW) 095200530

(51) Int. Cl. B25D 11/00

(52) U.S. Cl. 173/210; 173/128

(57) ABSTRACT

A pneumatic hammer drill includes a handle body, a pneumatic cylinder, a piston, and a shock-absorbing sleeve. The pneumatic cylinder has a cylinder rear end fitted in the handle body, a front tool-connecting end, and a pressure chamber. The piston is disposed slidably in the pressure chamber. A tool is inserted into the pressure chamber through the front tool-connecting end. A spring element is attached to the front tool-connecting end, and has a spring end connected to the tool for pulling the same rearwardly. The shock-absorbing sleeve is made of a resilient material, is inserted into the front tool-connecting end around the tool, and has a front end to abut against the tool when the tool is pulled rearwardly.

### CROSS-REFERENCE TO RELATED APPLICATION

This application claims priority of Taiwanese Application No. 095200530, filed on Jan. 10, 2006.

### BACKGROUND OF THE INVENTION

1. Field of the Invention

The invention relates to a pneumatic hand tool, more particularly to a pneumatic hammer drill.

2. Description of the Related Art

Referring to FIG. 1, a conventional hammer drill includes a handle body 10 defining a cavity 111 and having a handgrip 11, a pneumatic cylinder 12, an air valve 122, and a tool 14. The pneumatic cylinder 12 is fitted partially into the cavity 111, and includes an externally threaded front end 1213 extending outwardly from the cavity 111, a spring element 123 fitted around the front end 1213, a pressure chamber 1211, a piston 13 inserted slidably into the pressure chamber 1211, and an air passage 1212 in fluid communication with the pressure chamber 1211 and the air valve 122. Highly compressed air is introduced into the air passage 1212 via the handgrip 11. The spring element 123 has a spring end 1231 extending outwardly and curvedly from a front end thereof.

The air valve 122 is disposed in the cavity 111 adjacent to the pneumatic cylinder 12, and includes interconnected front and rear valve casings 1221, 1222, and a diaphragm 1223. The front valve casing 1221 is provided with a valve orifice (1221a). The rear valve casing 122 is provided with a valve orifice (1222a), and a valve seat 1224 to receive the diaphragm 1223 therein.

The tool 14 is inserted into the pressure chamber 1211 through the front end 1213 of the pneumatic cylinder 12, and has an annular protrusion 141 proximate to a rear portion thereof and located between a front end face of the front end 1213 and the spring end 1231 of the spring element 123.

The compressed air flows through the valve orifices (1221a, 1222a) from the air passage 1212 in the pneumatic cylinder 12, and enters a rear side of the pressure chamber 1211 so as to push forwardly the piston 13, which in turn, strikes the tool 14 so that the tool 14 produces a hammering force on a workpiece. The tool 14 cannot be released from the pneumatic cylinder 12 as the annular protrusion 141 thereof is engaged with the spring end 1231 of the spring element 123. When the compressed air enters a front side of the pressure chamber 1211 via the air passage 1212, the piston 13 is pushed rearwardly toward the front valve casing 1221 so that the tool 14 is restored to its original position through a restoring force of the spring element 123. Hence, by moving the piston 13 reciprocatingly in the pressure chamber 1211 through such supply of the compressed air, a hammering action of the tool 14 is effected.

Although the aforementioned conventional hammer drill can achieve its intended purpose, it has many drawbacks. Firstly, there is no seal between the tool 14 and the pneumatic cylinder 12 so that the compressed air leaks out easily from a gap between the same. As a result, insufficient pressure is developed in the pressure chamber 1211 which reduces the hammering force of the tool 14. Further, since contact surfaces between the front end 1213 of the pneumatic cylinder 12 and the annular protrusion 141 of the tool 14 are generally flat, and since the impact of the tool 14 against the pneumatic cylinder 12 is strong when the tool 14 is restored to its original position by the restoring force of the spring element 123, the internal components in the pneumatic cylinder 12 are prone to damage. Moreover, because of the strong impact force, an operator's hand is easily fatigued and may even become injured. Additionally, the strong impact produces an unpleasant loud noise that may even adversely affect the sense of hearing of the operator.

### SUMMARY OF THE INVENTION

Therefore, the object of the present invention is to provide a pneumatic hammer drill that has a shock-absorbing sleeve which can provide good damping and air-sealing effects.

According to this invention, a pneumatic hammer drill comprises a handle body, a pneumatic cylinder, a piston, a tool, a spring element, and a shock-absorbing sleeve. The pneumatic cylinder has a cylinder rear end fitted in the handle body, a front tool-connecting end, and a pressure chamber. The piston is disposed slidably in the pressure chamber. The tool is inserted into the pressure chamber through the front tool-connecting end. The spring element is attached to the front tool-connecting end, and has a spring end connected to the tool for pulling the tool rearwardly. The shock-absorbing sleeve is made of a resilient material, is inserted into the front tool-connecting end around the tool, and has a front end to abut against the tool when the tool is pulled rearwardly.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional pneumatic hammer drill;

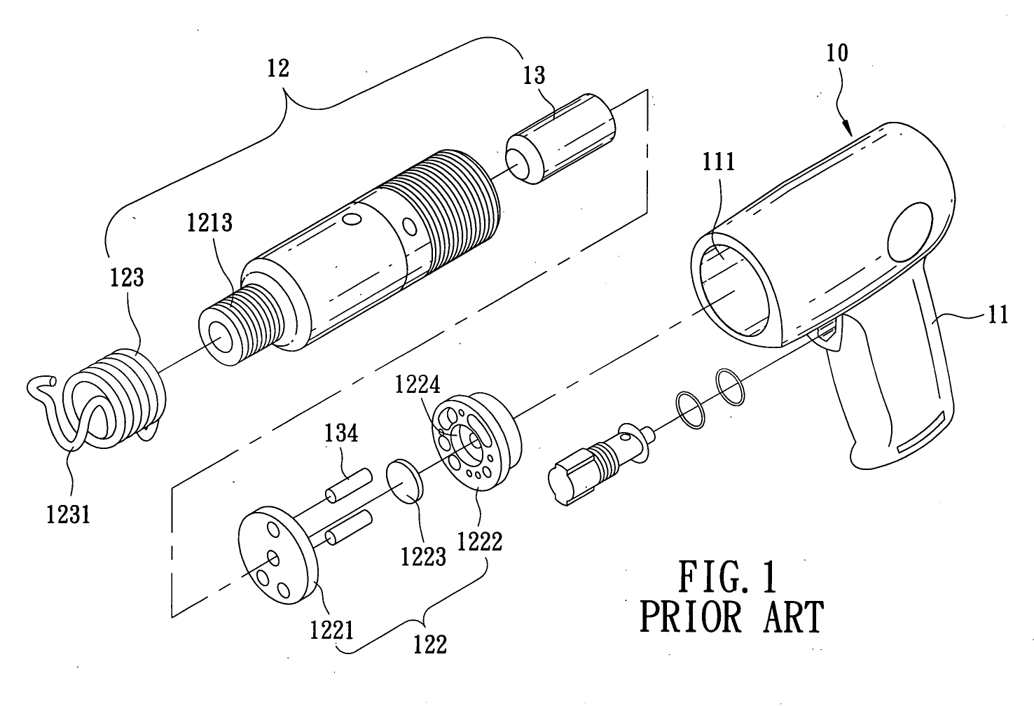

FIG. 2 is a fragmentary sectional view of the conventional pneumatic hammer drill in an assembled state;

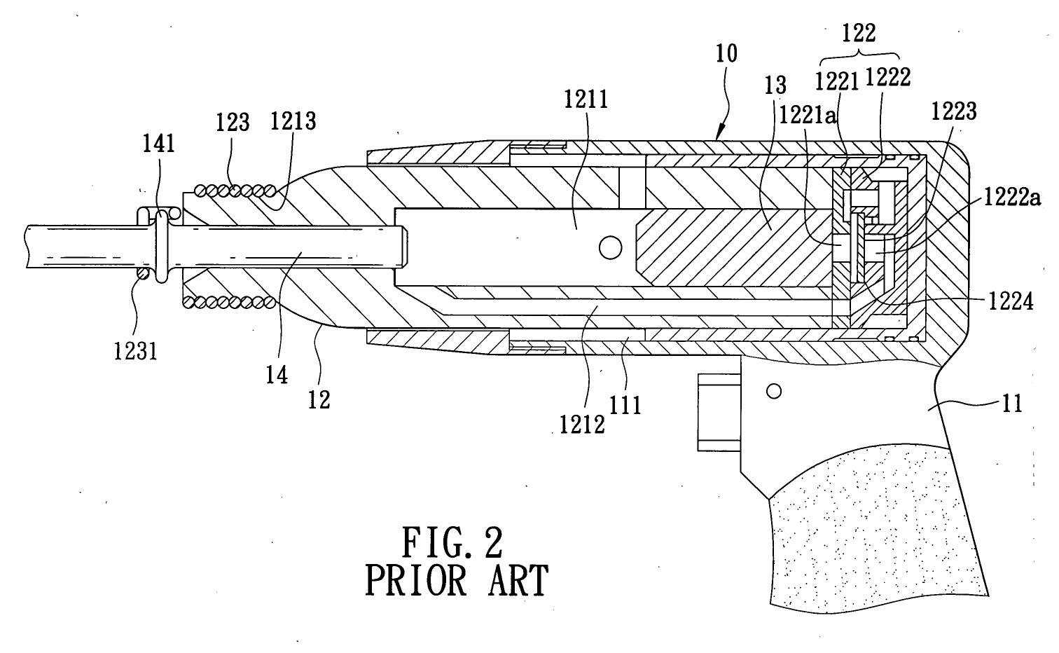

FIG. 3 is an exploded perspective view of the first preferred embodiment of a pneumatic hammer drill according to the present invention;

FIG. 4 is an assembled sectional view of the first preferred embodiment;

FIG. 5 is an assembled sectional view of the second preferred embodiment of a pneumatic hammer drill according to the present invention;

FIG. 6 is an enlarged perspective view of a shock-absorbing sleeve of the second preferred embodiment;

FIG. 7 is an enlarged fragmentary sectional view of the second preferred embodiment;

FIG. 8 is a perspective view of a shock-absorbing sleeve of the third preferred embodiment of a pneumatic hammer drill according to the present invention;

FIG. 9 is a schematic bottom view of the shock-absorbing sleeve of FIG. 8; and

FIG. 10 is an enlarged fragmentary sectional view of the third preferred embodiment.

### DETAILED DESCRIPTION OF THE PREFERRED EMBODIMENTS

Before the present invention is described in greater detail, it should be noted that like elements are denoted by the same reference numerals throughout the disclosure.

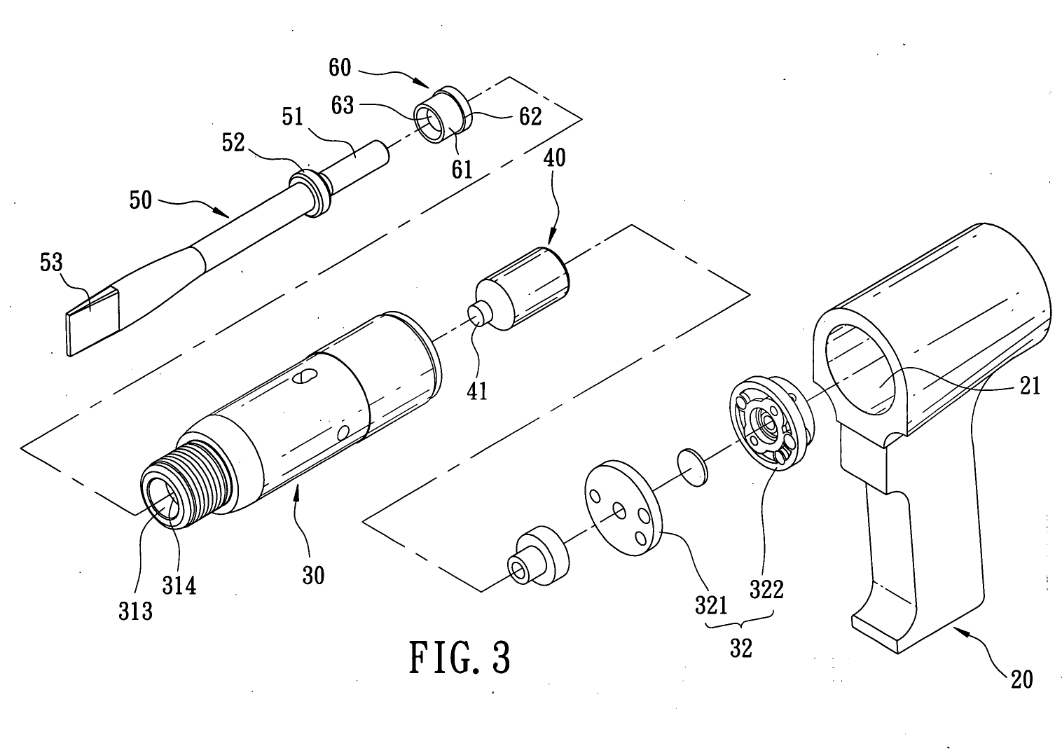

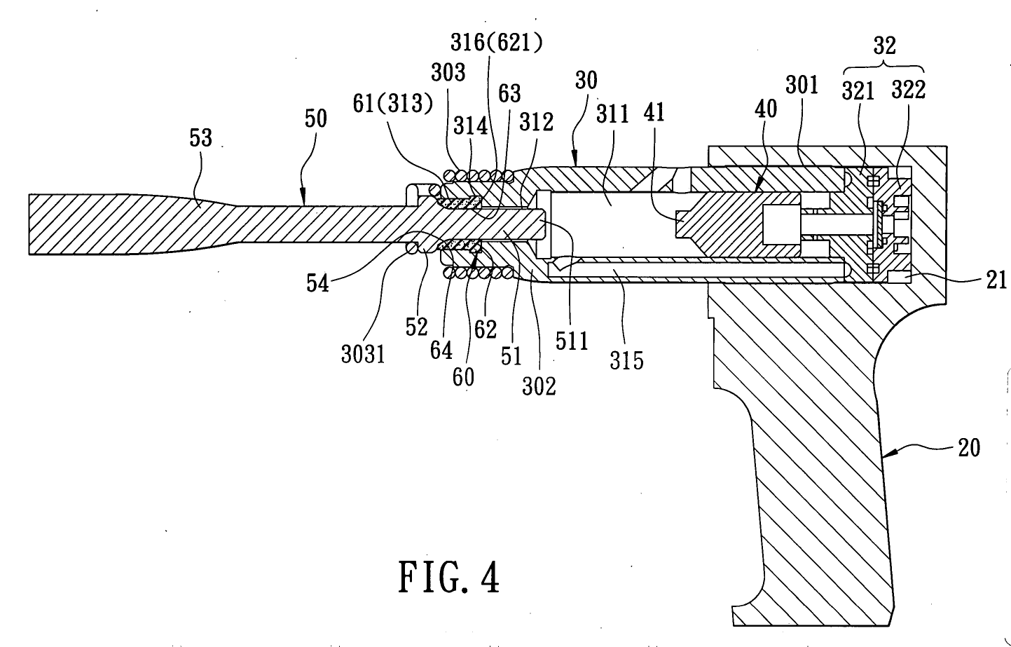

Referring to FIGS. 3 and 4, the first preferred embodiment of a pneumatic hammer drill according to the present invention is shown to comprise a handle body 20, a pneumatic cylinder 30, a piston 40, a tool 50, and a shock-absorbing sleeve 60.

The handle body 20 defines a receiving space 21 at a top portion thereof. Compressed air can be introduced into the handle body 20 through a bottom end thereof.

The pneumatic cylinder 30 has a cylinder rear end 301 fitted in the receiving space 21 of the handle body 20, a front tool-connecting end 302 extending outwardly of the receiving space 21, a spring element 303 fitted around the front tool-connecting end 302, a pressure chamber 311, and an air passage 315. The front tool-connecting end 302 has a rear hole section 312 adjacent to and in fluid communication with the pressure chamber 311, a front hole section 313 opposite to the rear hole section 312, and a retaining hole section 314 between the front and rear hole sections 313, 312. The front hole section 313 has a cross section larger than that of the rear hole section 312, but smaller than that of the retaining hole section 314. A shoulder 316 is formed between the retaining hole section 314 and the rear hole section 312. The spring element 303 has a spring end 3031 extending outwardly and curvedly from the front tool-connecting end 302.

An air valve 32 is fitted in the receiving space 21 of the handle body 20 rearwardly of the pneumatic cylinder 30, and includes a front valve casing 321, and a rear valve casing 322 abutting against the front valve casing 321.

The piston 40 is disposed slidably in the pressure chamber 311 of the pneumatic cylinder 30, and has a piston front end 41.

The tool 50 is inserted into the pressure chamber 311 through the front tool-connecting end 302, and has a rear shank portion 51, an annular protrusion 52, and a front chisel portion 53. The rear shank portion 51 extends consecutively through the front hole section 313, the retaining hole section 314, and the rear hole section 312, and has a rear end face 511 extending into the pressure chamber 311 to allow the piston front end 41 of the piston 40 to strike the rear shank portion 51 of the tool 50. The annular protrusion 52 is formed proximate to the rear shank portion 51, and has an annular shoulder face 54. The front chisel portion 53 extends forwardly from the rear shank portion 51, and is adapted to strike a workpiece. The tool 50 cannot be released from the pneumatic cylinder 30 as the annular protrusion 52 thereof is engaged with and is connected to the spring end 3031 of the spring element 303. The spring end 3031 pulls the tool 50 rearwardly when the piston 40 is moved rearwardly.

The shock-absorbing sleeve 60 is made of a resilient material. In this embodiment, the shock-absorbing sleeve 60 is made of rubber, and is inserted fittingly into the front hole section 313 of the pneumatic cylinder 30 around the rear shank portion 51 of the tool 50. The shock-absorbing sleeve 60 has a front portion 61 proximate to the annular protrusion 52 of the tool 50, an enlarged rear portion 62 fitted in the retaining hole section 314 so as to prevent removal of the shock-absorbing sleeve 60 from the front hole section 313, and a central through hole 63 for extension of the rear shank portion 51 of the tool 50 therethrough. The front portion 61 has a circular cross section, and a front end 64 extending outwardly of the front hole section 313 to abut against the annular shoulder face 54 of the tool 50. Both of the front end 64 and the annular shoulder face 54 are formed respectively with rounded corners that abut against each other. The enlarged rear portion 62 has a rear end face 621 abutting against the shoulder 316 in the front tool-connecting end 302.

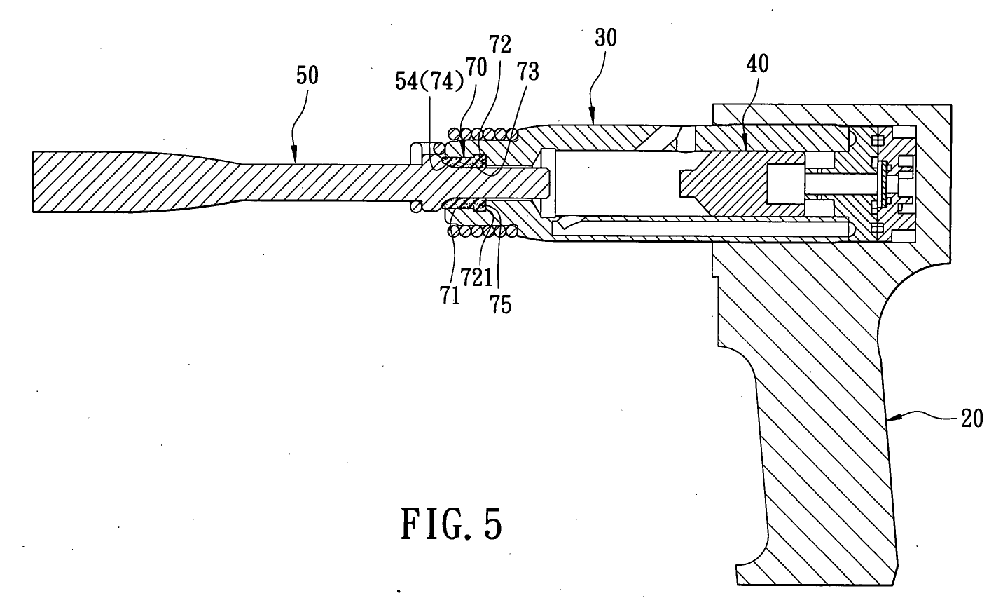

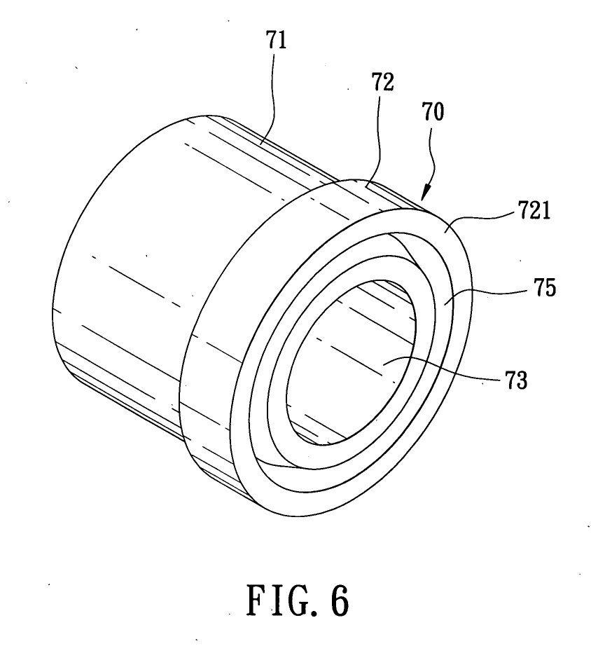

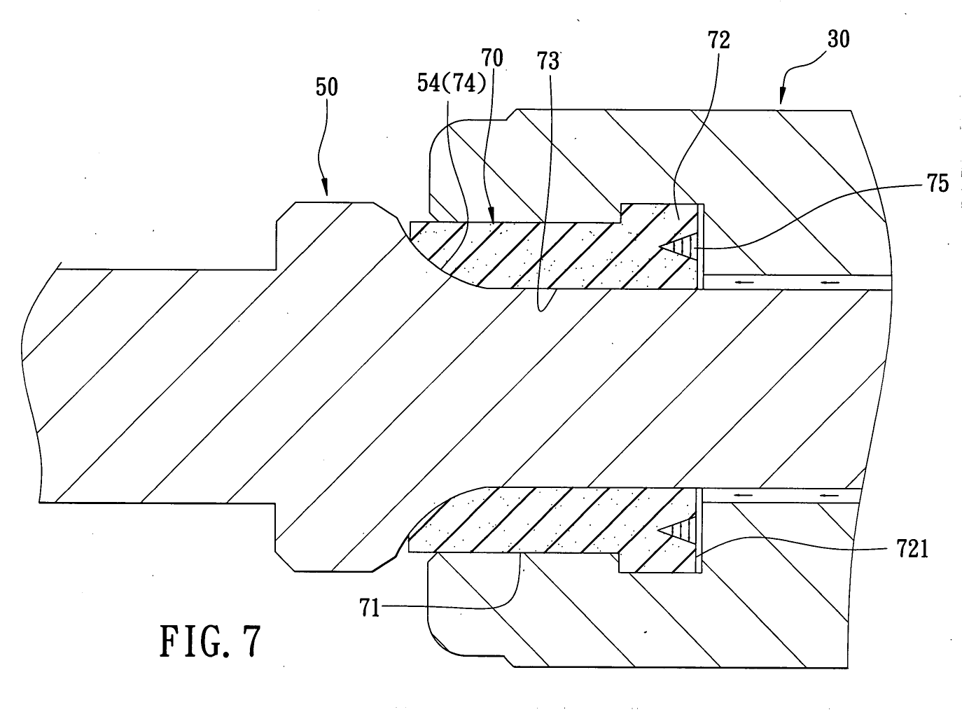

FIGS. 5 to 7 show a shock-absorbing sleeve 70 according to the second preferred embodiment of the present invention. The shock-absorbing sleeve 70 has a front portion 71, an enlarged rear portion 72 that has a rear end face 721, and a central through hole 73. The front portion 71 has a front end 74 to abut against the annular shoulder face 54 of the tool 50. The rear end face 721 of the enlarged rear portion 72 is provided with an annular groove 75 that extends around the tool 50 and that opens at the rear end face 721 so as to increase an expansibility/compressibility of the shock-absorbing sleeve 70. If the compressed air leaks through a gap between the pneumatic cylinder 30 and the tool 50, air will be received in the annular groove 75 so that the enlarged rear portion 72 of the shock-absorbing sleeve 70 expands to ensure tight sealing contact with the pneumatic cylinder 30 and the tool 50.

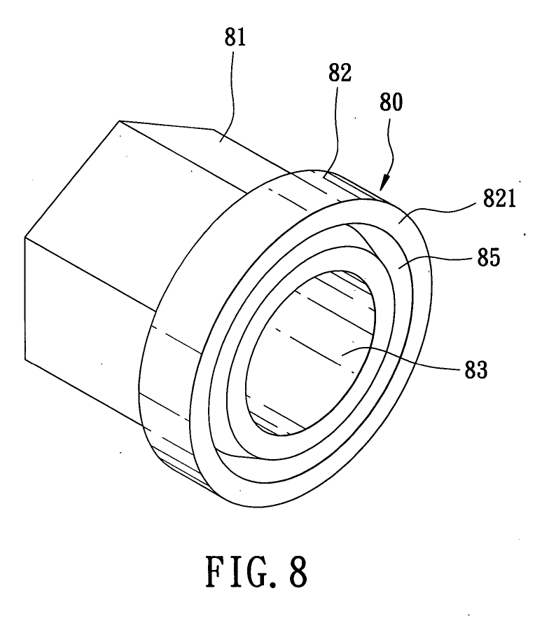

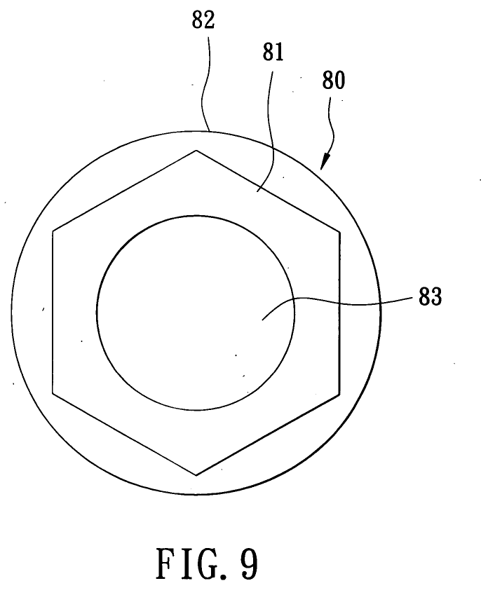

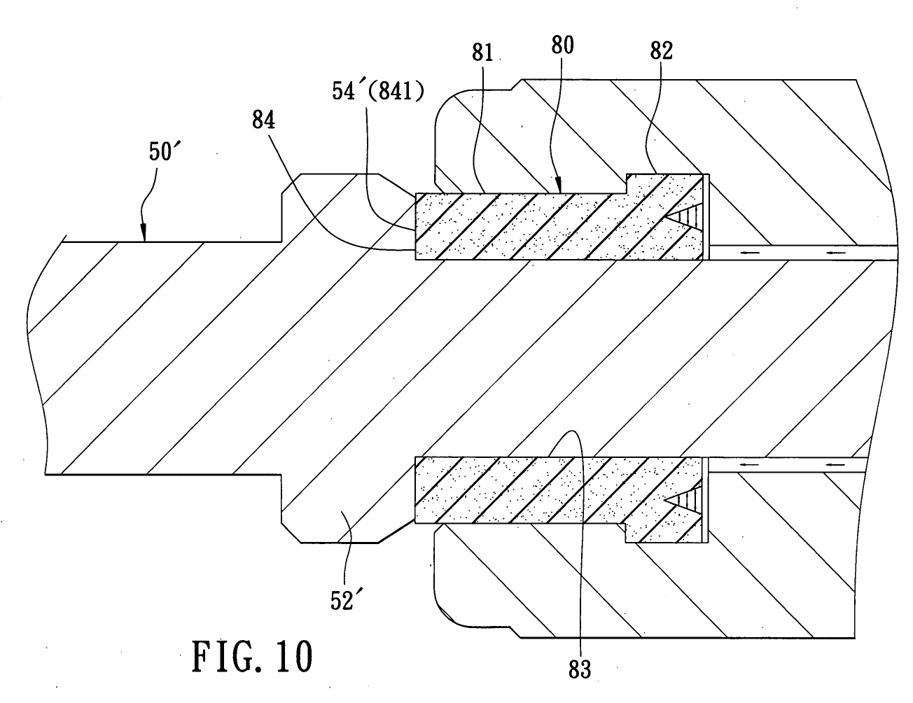

FIGS. 8 to 10 show a shock-absorbing sleeve 80 according to the third preferred embodiment of the present invention. The shock-absorbing sleeve 80 has a front portion 81, an enlarged rear portion 82 that has a rear end face 821 provided with an annular groove 85, and a central through hole 83. The front portion 81 has a hexagonal cross section, and further has a front end 84 formed with a right-angled corner 841. The tool 50′ has a right-angled shoulder face 54′ to abut against the right-angled corner 841 of the front end 84.

From the aforementioned description, the advantages of the present invention can be summarized as follows:

1. The shock-absorbing sleeve 60, 70, 80 is provided between the pneumatic cylinder 30 and the tool 50, 50′ so as to fill and seal a gap between the same. As such, the compressed air in the pressure chamber 311 cannot leak out easily via the gap, and pressure inside the pressure chamber 311 will be sufficient enough so that the piston 40 is struck against the tool 50 with a significant force.

2. An impact force of the tool 50 against the pneumatic cylinder 30 when the tool 50 is pulled rearwardly by the spring element 303 is dampened by the shock-absorbing sleeve 60, 70, 80, so that the problems associated with strong impact forces as encountered in the aforementioned conventional pneumatic hammer drill are resolved.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A pneumatic hammer drill, comprising:
a handle body;
a pneumatic cylinder having a cylinder rear end fitted in said handle body, a front tool-connecting end, and a pressure chamber;
a piston disposed slidably in said pressure chamber;
a tool inserted into said pressure chamber through said front tool-connecting end;
a spring element attached to said front tool-connecting end and having a spring end connected to said tool for pulling said tool rearwardly; and
a shock-absorbing sleeve made of a resilient material and inserted into said front tool-connecting end around said tool, said shock-absorbing sleeve having a front end to abut against said tool when said tool is pulled rearwardly.

2. The pneumatic hammer drill of claim 1, wherein said shock-absorbing sleeve is made of rubber.

3. The pneumatic hammer drill of claim 1, wherein said front tool-connecting end has a rear hole section adjacent to said pressure chamber, and a front hole section that has a cross section larger than that of said rear hole section, said shock-absorbing sleeve being received fittingly in said front hole section, said tool extending into said pressure chamber through said shock-absorbing sleeve and said rear hole section.

4. The pneumatic hammer drill of claim 3, wherein said front tool-connecting end further has a retaining hole section between said front and rear hole sections, said retaining hole section having a cross section larger than that of said front hole section, said shock-absorbing sleeve having a front portion that has said front end, and an enlarged rear portion fitted in said retaining hole section.

5. The pneumatic hammer drill of claim 4, wherein said front tool-connecting end further has a shoulder between said retaining hole section and said rear hole section, said enlarged rear portion of said shock-absorbing sleeve having a rear end face abutting against said shoulder and provided with an annular groove that extends around said tool and that opens at said rear end face.

6. The pneumatic hammer drill of claim 4, wherein said front portion of said shock-absorbing sleeve has a circular cross section.

7. The pneumatic hammer drill of claim 4, wherein said front portion of said shock-absorbing sleeve has a hexagonal cross section.

8. The pneumatic hammer drill of claim 1, wherein said tool has an annular protrusion proximate to said front end of said shock-absorbing sleeve, said annular protrusion having an annular shoulder face to abut against said front end of said shock-absorbing sleeve.
